(19) United States
(12) Patent Application Publication
(10) Pub. No.: US 2024/0234878 A9
(43) Pub. Date: Jul. 11, 2024

(54) PACKAGING MATERIAL

(71) Applicant: Resonac Packaging Corporation, Hikone-shi (JP)

(72) Inventor: Keitaro KAWAKITA, Hikone-shi (JP)

(73) Assignee: Resonac Packaging Corporation, Hikone-shi (JP)

(21) Appl. No.: 18/138,124

(22) Filed: Apr. 24, 2023

(30) Foreign Application Priority Data
Apr. 25, 2022 (JP) 2022-071704
Mar. 15, 2023 (JP) 2023-040851

(51) Int. Cl. H01M 50/126; H01M 50/119; H01M 50/121; H01M 50/124

(52) U.S. Cl. CPC H01M 50/126; H01M 50/119; H01M 50/121; H01M 50/1245

(57) ABSTRACT

A packaging material excellent in moldability, colorability, and strength is provided. The packaging material includes a substrate layer made of a heat-resistant resin, a metal foil layer laminated on an inner side of the substrate layer, a sealant layer made of a thermoplastic resin laminated on an inner side of the metal foil layer, and a colored adhesive layer provided between the metal foil layer and the substrate layer. The colored adhesive layer is formed of a colored adhesive cured film containing a color pigment and an adhesive. The colored adhesive cured film has a Young's modulus of 450 MPa to 700 MPa by a tensile test according to JIS K7161-1: 2014.

### TECHNICAL FIELD

The present invention relates to a packaging material as an external material for a battery (power storage device), such as, e.g., a notebook computer, a mobile telephone, a vehicle-mounted (mobile) or a stationary secondary battery (lithium-ion secondary battery), or the like. It also relates to a packaging material for foods or pharmaceutical products, a packaging container, a power storage device, and a production method of a colored adhesive composition.

### BACKGROUND OF THE INVENTION

A battery, such as, e.g., a lithium-ion secondary battery, is often required to be colored to match the appearance and the color of a device, such as, e.g., an electric device to which the battery is mounted. In particular, in order to impart a profound feeling and a luxury feeling, the device is often made black. In this case, the battery is also often made black.

As a packaging material of this type of the equipment, it is common to use a laminate in which a resin substrate layer is laminated on the outer surface side of a metal foil layer, and a resin sealant layer is laminated on the inner surface side of the metal foil layer. As a means for coloring a battery in black or the like, there are, for example, a means for coloring a resin layer used for a packaging material, a means for providing a print layer below a substrate layer, a means for coloring an adhesive layer between a substrate layer and a metal layer, and a means for coloring an adhesive layer between layers in a case where a substrate layer is composed of a plurality of layers.

For example, in Patent Document 1, an example is disclosed in which a pigment is added to an adhesive layer disposed between a substrate layer and a metal foil layer of a battery packaging material to serve an identification label. Patent Document 1 also describes that when the pigment additive amount is 10 mass % to 30 mass %, the discrimination can be performed, and the moldability is also good.

Further, in Patent Document 2, an example is shown in which a substrate layer is configured by a plurality of layers (two layers), and a pigment is added to an adhesive layer disposed between the two substrate resin layers to serve an identification label. Patent Document 2 describes that when the pigment additive amount is 5 mass % to 30 mass %, the discrimination can be performed, and the moldability is also good.

However, in a case where a pigment, such as, e.g., a carbon black, is added to the adhesive layer disposed between the substrate layer and the metal foil layer, when the amount of the carbon black added to the adhesive layer is increased in order to make the adhesive layer black, the following problems occur. That is, the adhesive force deteriorates, and the delamination occurs between the substrate layer and the adhesive layers during molding, so that the molding into a predetermined shape cannot be performed in some cases.

Such delamination (partial delamination) between the substrate layer and the adhesive layer is not limited to occur only at the time of molding. That is, delamination occurs when sealing a black packaging material after encapsulation of an electrode and/or an electrolyte, or when a battery packaged with a black packaging material is used under a somewhat harsh environment, such as, e.g., a high-temperature and high-humidity environment.

Note that the delamination problem does not occur only in a black packaging material using a carbon black and may also occur in a packaging material colored with other pigments in the same manner.

Under such circumstances, Patent Document 3 discloses a technique in which an additive amount of a color pigment, such as, e.g., a carbon black, is specified within a predetermined range, thereby suppressing adhesive force reduction caused by adding a pigment to an adhesive layer to obtain good moldability.

### PRIOR ART DOCUMENT

### Patent Document

[Patent Document 1] Japanese Unexamined Patent Application Publication No. 2011-054563
[Patent Document 2] Japanese Unexamined Patent Application Publication No. 2015-072911
[Patent Document 3] Japanese Unexamined Patent Application Publication No. 2021-109706

### SUMMARY OF THE INVENTION

### Problems to be Solved by the Invention

As described above, in the case of coloring the packaging material by adding a pigment, such as, e.g., a carbon black, to an adhesive layer, it is one of the important key factors to specify the additive amount of the pigment within a predetermined range.

However, merely setting the amount of the pigment added to the adhesive layer to a specific range may result in non-uniform dispersion of the pigment in the adhesive layer. Therefore, the pigment particles are unevenly aggregated to form a defect in the adhesive layer, deteriorating the adhesive force, which in turn decreases the Young's modulus of the adhesive layer. For this reason, when molding into a container (casing) by deep drawing or stretch forming, the external force at the time of the molding processing cannot be efficiently dispersed, and a predetermined moldability cannot be obtained.

Preferred embodiments of the present invention have been made in view of the above-described and/or other problems in the related art. The preferred embodiments of the present invention can significantly improve upon existing methods and/or devices.

The present invention has been made in view of the above-described problems, and an object of the present invention is to provide a packaging material having excellent moldability and colorability, a packaging container using the packaging material, a packaging material for a power storage device, a power storage device, and a method of producing a colored adhesive composition.

Other objects and advantages of the present invention will be apparent from the following preferred embodiments.

### Means for Solving the Problem

In order to solve the above-described problems, the present invention includes the following means.

[1] A packaging material comprising:
a substrate layer made of a heat-resistant resin;
a metal foil layer laminated on an inner side of the substrate layer;
a sealant layer made of a thermoplastic resin, the sealant layer being laminated on an inner side of the metal foil layer; and
a colored adhesive layer provided between the metal foil layer and the substrate layer,
wherein the colored adhesive layer is formed of a colored adhesive cured film containing a color pigment and an adhesive, and
wherein the colored adhesive cured film has a Young's modulus of 450 MPa to 700 MPa by a tensile test according to JIS K7161-1: 2014.

[2] The packaging material as recited in the above-described Item 1,
wherein the colored adhesive cured film has breaking elongation of 21% to 60% by a tensile test according to JIS K7161-1:2014.

[3] The packaging material as recited in the above-described Item 1 or 2,
wherein the colored adhesive layer contains the color pigment of 2 masse or more and less than 5 mass %, and
wherein the colored adhesive layer is a colored adhesive cured film of 5 g/m² to 10 g/m².

[4] The packaging material as recited in any one of the above-described Items 1 to 3,
wherein the adhesive of the colored adhesive layer contains a two-part curing type polyester urethane resin derived from a polyester resin as a main agent and a polyfunctional isocyanate compound as a curing agent,
wherein the polyester resin as the main agent has a number average molecular weight (Mn) of 8,000 to 25,000 and a weight average molecular weight (Mw) of 15,000 to 50,000, and a ratio thereof (Mw/Mn) is 1.3 to 2.5,
wherein the polyfunctional isocyanate compound as the curing agent contains 50 mole % or more of aromatic isocyanate.

[5] The packaging material as recited in the above-described Item 4,
wherein in the two-part curing type polyester urethane resin, the polyester resin as the main agent is made from dicarboxylic acid and dialcohol, and
wherein the dicarboxylic acid contains aliphatic dicarboxylic acid in which a methylene number of a methylene chain and aromatic dicarboxylic acid is an even number, and a content rate of the aromatic dicarboxylic acid with respect to a total amount of the aliphatic dicarboxylic acid and aromatic dicarboxylic acid is 40 mol % to 80 mol %.

[6] The packaging material as recited in any one of the above-described Items 1 to 5,
wherein the metal foil layer has a chemical conversion coating film on at least one surface of the metal foil layer.

[7] The packaging material as recited in any one of the above-described Items 1 to 6, further comprising;
a matte coat layer provided on an outer surface of the substrate layer.

[8] A packaging container made of the packaging material as recited in any one of the above-described Items 1 to 7,
wherein the packaging material is provided with a molded portion formed by subjecting the packaging material to deep drawing or stretch forming.

[9] A packaging material for a power storage device, the packaging material being the packaging material as recited in any one of the above-described Items 1 to 7 and/or the packaging container as recited in the above-described Item 9.

[10] A power storage device comprising:
a power storage device main body; and
the packaging material as recited in the above-described Item 8,
wherein the power storage device main body is covered with the packaging material.

[11] A method of producing a colored adhesive composition constituting the colored adhesive cured film in the packaging material as recited in any one of the above-described Items 1 to 7, the method comprising:
mixing a color pigment with a vehicle to prepare a liquid coloring agent;
mixing the liquid coloring agent with a main agent among the main agent and a curing agent constituting the adhesive to prepare pigment-containing adhesive main agent; and then
mixing the pigment-containing adhesive main agent and the curing agent to produce the colored adhesive composition.

### Effects of the Invention

According to the packaging material of the above-described Invention [1], since the colored adhesive layer contains a pigment, good coloring can be obtained. Further, since the Young's modulus of the colored adhesive layer containing the color pigment is specified within a predetermined range, it is possible to efficiently disperse the action from the external pressure, which in turn can obtain enough strength and excellent moldability. Therefore, for example, it is possible to mold the packing material into a sharp and deep shape. Therefore, it is possible to prevent the colored adhesive layer from being partially crack and peeled off even at the time of molding and sealing or even at the time of using under high-temperature and high-humidity severe environments.

According to the packaging material of the above-described invention [2], since the breaking elongation is specified within a predetermined range, good moldability can be obtained when performing deep drawing and stretch forming. Further, the substrate layer will not be peeled off, and the bonding property of the substrate layer can be further improved, which can suppress the occurrence of delamination.

According to the packaging material of the Invention [3], since the colored adhesive layer is a colored adhesive cured film of a predetermined quantity, and the density (content rate) of the color pigment in the colored adhesive layer is specified within a predetermined range, it is possible to obtain a uniform coloring property as a whole. Further, it is possible to prevent the weakening of the colored adhesive layer due to the inclusion of the color pigment and increase the breaking path (distance) of the colored adhesive cured film to improve the breaking elongation, which can sufficiently maintain the adhesive property between the substrate layer and the metal foil layer. Therefore, better moldability can be obtained when performing deep drawing and stretch forming. Moreover, the substrate layer does not peel off to lose its appearance even if it is left in a high-temperature and high-humidity environment after molding. Consequently, even in an evaluation test influenced by the inclusion of the color pigment and in a hot water submersion test, which is the most severe environmental test, the substrate layer will not be peeled off, and the bonding property of the substrate layer can be further improved.

According to the packaging material of the invention [4], the colored adhesive layer contains a particular two-part curing type polyester urethane resin. Therefore, it is possible to obtain a moderate strength and elongation and an excellent heat resistance. Further, the polyester resin, which is a main agent of the colored adhesive layer, is adjusted to a predetermined molecular weight distribution, and therefore, it is excellent in adhesive coating suitability. Further, the polyamide film as a substrate layer is adjusted to a predetermined molecular weight distribution. Therefore, the film as a substrate layer is hard to break and good piercing resistance can be obtained.

According to the packaging material of the above-described invention [5], the polyester resin as a main agent is composed of a specific composition in the two-part curing type polyester urethane resin contained in the colored adhesive layer. Therefore, the adhesive property can be further enhanced, which in turn can more assuredly prevent the delamination between the substrate layer and the metal foil layer.

According to the packaging material of the above-described invention [6], the chemical conversion coating film is provided on the surface of the metal foil layer. Therefore, the metal foil layer can be prevented from being corroded, which can improve the corrosion resistance of the entire packaging material.

According to the packaging material of the above-described invention (7), a matte coat layer is provided on the surface of the substrate layer. Therefore, the moldability and the durability can be further improved. Further, the presence of the matte coat layer improves the appearance quality of the packaging material and prevents defects, such as, e.g., the adhesion defect between the packaging materials, and facilitates the handling of the packaged product.

According to the packaging container of the above-described invention [8], since the packaging material of the above-described invention is used, the same advantages as those described above can be obtained.

According to the packaging material for a power storage device of the above-described invention [9], since the packaging material and the packaging container of the present invention are used, the came effects as those described above can be obtained.

According to the power storage device of the above-described invention [10], since the packaging material of the present invention is used, the same effects as those described above can be obtained.

According to the production method of the above-described invention [11], since the colored adhesive composition in which color pigments are uniformly dispersed can be produced, the colored adhesive cured film having the above-described specific physical properties can be assuredly formed.

### BRIEF DESCRIPTION OF THE DRAWINGS

FIG. 1 is a side cross-sectional view showing a power storage device according to one embodiment of the present invention.

FIG. 2 is an exploded perspective view showing a power storage device according to one embodiment of the present invention.

FIG. 3 is a schematic cross-sectional view schematically showing a power storage device packaging material according to an embodiment,

FIG. 4 is a schematic diagram for explaining a machine direction (MD) and a transverse direction (TD) in a resin film.

FIG. 5 is an S-S curve diagram of a cured film of a two-part curing type polyester urethane resin adhesive.

FIG. 6 is a perspective view showing a molded article of a packaging material sample used in an example of the present invention.

### EMBODIMENTS FOR CARRYING OUT THE INVENTION

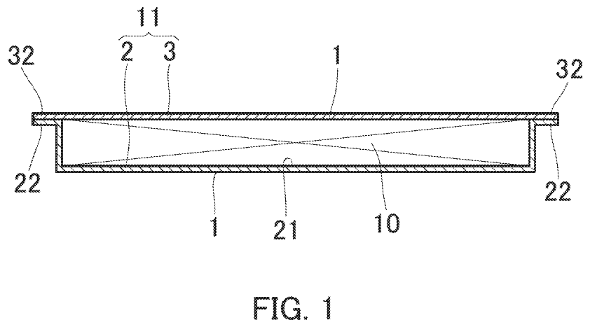

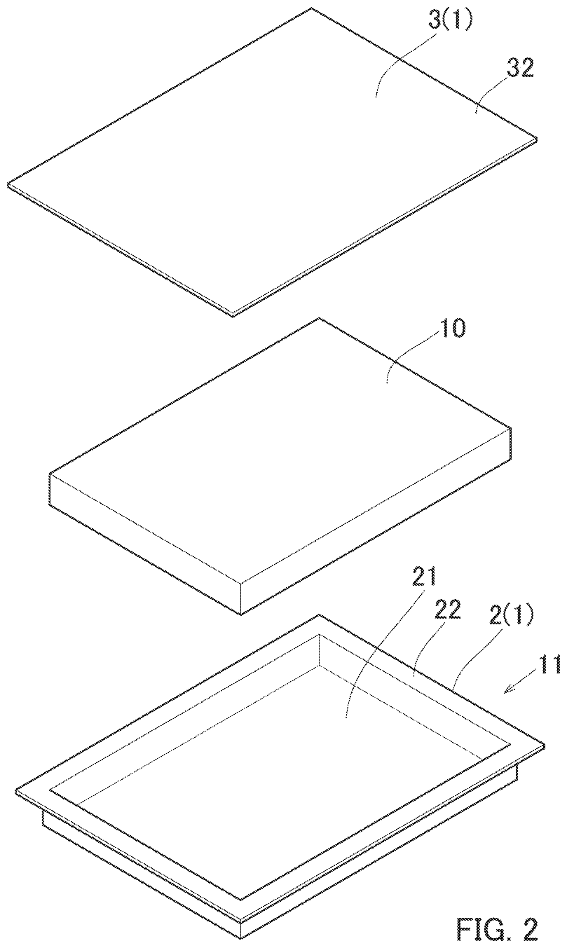

FIG. 1 is a side cross-sectional view showing a power storage device according to one embodiment of the present invention. FIG. 2 is an exploded perspective view showing a power storage device according to one embodiment of the present invention.

As shown in FIG. 1 and FIG. 2, the power storage device of this embodiment is provided with a casing 11 and a power storage device main body 10, such as, e.g., an electrochemical element to be accommodated in the casing 11.

The casing 11 is constituted by a tray member (packaging container) 2 having a rectangular shape in plan view, the tray member being formed by an exterior material 1, and a cover member 3 having a flat shape in plan view, the cover member being formed by the exterior material (packaging material) 1.

The tray member 2 is formed of a molded article obtained by molding a packaging material 1 using a method, such as, e.g., deep drawing. In the tray member 2, the entire intermediate region excluding the outer peripheral edge portion is recessed downward, and a recessed portion 21 having a rectangular shape in plan view is formed. Further, an outwardly protruding flange portion 22 is integrally formed on the outer periphery of the opening edge portion of the recessed portion 21.

Further, the cover member 3 is constituted by the packaging material 1 formed in a sheet-like shape. In the cover member 3, the outer peripheral edge portion is configured as a flange portion 32 corresponding to the flange portion 22 of the tray member 2.

The packaging material 1 as the tray member 2 and the cover member 3 are each constituted by an outer packaging laminate, which is a laminate sheet or a film with softness and flexibility.

The power storage device main body 10 is not particularly limited, and the examples thereof include a battery main body, a capacitor main body, and a condenser main body. The power storage device main body 10 is formed into a shape corresponding to the recessed portion 21 of the tray member 2.

Then, in a state in which the power storage device main body 10 is accommodated in the recessed portion 21, the cover member 3 is disposed on the tray member 1 to cover the recessed portion 21, and the flange portion 22 of the tray member 2 and the flange portion 32 of the cover member 3 are thermally fused to each other. With this, the power storage device of this embodiment is formed.

Although not shown, one end (inner end) of a tab lead is connected to the power storage device main body 10, and the other end (outer end) thereof is drawn out of the power storage device. Thus, electric power can be input to and output from the power storage device main body 10 via the tab-lead.

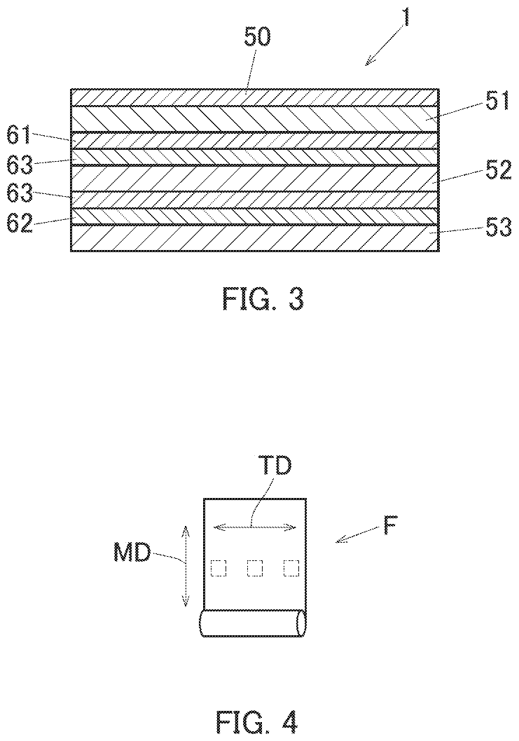

FIG. 3 is a schematic cross-sectional view schematically showing the basic configuration of the outer packaging laminate material constituting the packaging material 1 in this embodiment. As shown in the figure, the packaging material (laminate material) 1 used in this embodiment is provided with a substrate layer (heat-resistant resin layer) 51, a metal foil layer (barrier layer) 52, and a sealant layer (heat-fusible resin layer) 53. The metal foil layer (barrier layer) 52 is bonded to one surface (inner surface) of the substrate layer 51 via a first adhesive layer 61 as a colored adhesive layer or an outer side adhesive layer. The sealant layer (heat-fusible resin layer) 53 is bonded to one surface (inner surface) of the metal foil layer 52 via a second adhesive layer 62 as an inner adhesive layer.

A chemical conversion coating film 63, 63 is formed on both surfaces of the metal foil layer 52. The matte coat layer 50 is laminated on the outer surface of the substrate layer 51.

In this embodiment, the substrate layer 51 is formed of, for example, a polyamide film, a polyester film, or a stretched film thereof. Among them, in terms of moldability and strength, it is preferable to use a biaxially stretched polyamide film, a biaxially stretched polybutylene terephthalate (PBT) film, a biaxially stretched polyethylene terephthalate (PET) film, or a biaxially stretched polyethylene naphthalate (PEN) film.

Further, as the polyamide film, a 6 nylon film, a 6,6 nylon film, an MXD nylon film, etc., are exemplified.

The substrate layer 51 may be a single-layer structure of a multi-layer structure. In the case of forming the substrate layer by a multi-layer structure, a multi-layer structure composed of a PET film/a polyamide film can be exemplified.

On the lower surface of the stretched film used as the substrate layer 51, i.e., on the bonding surface with the first adhesive layer 61, it is desirable to subject the surface to an easy adhesion treatment to impart wettability for the purpose of improving the adhesive strength with the adhesive layer 61.

The substrate layer 51 of a power storage device packaging material is desired to have higher moldability and piercing resistance in order to increase the capacity and improve the safety of the power storage device (battery). According to the research by the present inventors, it has been found that it is more suitable to use a polyamide film than a polyester film to improve the latter performance (the piercing resistance). More preferably, when a polyamide film satisfying the following physical properties (1) to (5) is used as the substrate layer 51, good moldability and piercing resistance are obtained.

(1) The substrate layer 51 may be preferably adjusted to 2.0% to 5.0%, more preferably adjusted to 2.5% to 4.5%, in the hot water shrinkage in the TD and the hot water shrinkage in the MD.

As shown in FIG. 4, the term “MD” denotes a machine direction and refers to the molding direction of the resin film F, i.e., the flow direction of the resin. The term “TD” denotes a transverse direction and refers to the direction perpendicular to the MD.

Further, the hot water shrinkage denotes a dimensional change rate in the shrinkage direction (stretching direction) before and after immersion of a film (measurement target) in hot water at 100° ° C. for 5 minutes. For example, when the dimension in the shrinkage direction (MD ox TD) before the hot water immersion is “X,” and the dimension in the shrinkage direction (MD or TD) after the hot water immersion is “Y,” the hot water shrinkage (%) in the shrinkage direction (MD or TD) is determined by a relational expression of {(X−Y)/X}*100.

Note that in the present invention, as the “hot water shrinkage” that indicates the characteristic value of the polyamide film, it is preferable to adopt an average value (average hot water shrinkage) of the hot water shrinkage. In the present invention, the average hot water shrinkage denotes an average value of the hot water shrinkages at three points, i.e., two points of both end portions and one point of the central portion, with respect to one direction of the sheet (film) to be measured. However, in the present invention, depending on the size of the power storage device main body 10, as the “hot water shrinkage” indicating the characteristic value of the polyamide film, it is also possible to adopt a hot water shrinkage (a hot water absorption rate at a reference position) measured at a certain position, which is not an average value.

(2) The difference between the hot water shrinkage of the substrate layer 51 in the MD and the hot water shrinkage in the ID may be preferably adjusted to 1.5% or less, more preferably 1.2% or less. Specifically, when the average hot water shrinkage in the MD is “MDz,” and the hot water shrinkage in the TD is “TDz,” it is preferable to establish the relational expression of |MDz−TDz|≤1.5%, and it is more preferably to adjust to establish the relational expression of |MDz−TDz|≤1.2%.

(3) The elastic modulus of the substrate layer 51 in the MD and the elastic modulus thereof in the TD are preferably adjusted to 1.5 GPa to 3 GPa, and more preferably adjusted to 2.0 GPa to 2.5 GPa.

(4) At least one of the breaking strength of the substrate layer 51 in the TD and the breaking strength thereof in the MD are preferably adjusted to 320 MPa or more, and more preferably adjusted to a 400 MPa or less.

(5) The number average molecular weight of the nylon as a polyamide film constituting the substrate layer 51 is preferably adjusted to 15,000 to 30,000, and more preferably adjusted to 20,000 to 25,000.

Here, when the hot water shrinkage in the TD and the hot water shrinkage in the MD in this embodiment is 2.0% or more, appropriate flexibility is provided, and good moldability can be secured as the substrate layer 51. Further, since the hot water shrinkage is 5.0% or less, excessive flexibility can be avoided as the substrate layer 51, and a desired strength can be maintained.

Further, in this embodiment, when the difference between the hot water shrinkage in the TD and the hot water shrinkage in the MD is adjusted to be within the above-described specified range, the force from the external pressure can be efficiently dispersed, which enables for the substrate layer 51 to assuredly maintain the desired strength.

Furthermore, when the elastic modulus in the ID and the elastic modulus in the MD are adjusted within the above-described specified range, appropriate flexibility and strength can be more assuredly maintained as the substrate layer 51.

Furthermore, when the breaking strength in the TD and the breaking strength in the MD are adjusted within the above-described specified range, the desired strength can be obtained more assuredly as the substrate layer 51.

By adopting a polyamide film having the above-described properties for the substrate layer 51 as described above, it is possible to obtain a packaging material 1 having good moldability and excellent piercing resistance.

Further, when the number average molecular weight of nylon as the substrate layer 51 is 15,000 or more, the substrate layer 51 is hardly broken. When the number average molecular weight of the nylon is 30,000 or less, the flexibility of the substrate layer 51 can be maintained, which less likely causes cracks.

Further, in this embodiment, the relative viscosity of the polyamide film as the substrate layer 51 is preferably adjusted to 2.9 to 3.1. In other words, in a case where the relative viscosity is adjusted to fall within the above-specified range, the strength and flexibility as the substrate layer 51 can be more effectively imparted, and it is possible to assuredly obtain the packaging material 1 excellent in moldability and high in piercing resistance.

In this embodiment, the piercing strength of the packaging material 1 is preferably within the range of 22 N to 30 N, more preferably 24 N to 30 N, and even more preferably 26 N to 30 N.

Further, in this embodiment, the thickness of the substrate layer 51 is preferably adjusted to 9 μm to 50 μm, and more preferably adjusted to 12 μm to 30 μm. In particular, when a polyester film is used as the substrate layer 51, the thickness is preferably adjusted to 9 μm to 50 μm, and when a polyamide film is used, the thickness is preferably adjusted to 10 μm to 50 μm. By setting the thickness to the suitable lower limit or more, satisfactory strength as a packaging material can be secured, and by setting the thickness to the suitable upper limit or less, the stresses at the time of stretch forming or deep drawing can be reduced and moldability can be improved.

Here, the distribution of the hot water shrinkage in the polyamide film of this embodiment will be described. First, in a square polyamide film, it is assumed that the hot water shrinkages at three points, i.e., the two points on both sides in the machine direction (MD) and one point at the center line, are defined as the fixed point hot water shrinkages as three points in the MD. Further, it is assumed that the hot water shrinkages at three points, i.e., two points at both sides and one point at the center line in the transverse direction (TD) are defined as the hot fixed water shrinkages at three points in the TD. In this case, it is preferable to use a film in which the difference between the largest fixed point hot water shrinkage and the smallest fixed point hot water shrinkage, among a total of six fixed point hot water shrinkages, i.e., three fixed point hot water shrinkages in the MD and three fixed point hot water shrinkages in the TD, is adjusted to 2.5 or less.

Note that the average value of the fixed point hot water shrinkage at three points in the machine direction (MD) corresponds to the average hot water shrinkage in the machine direction (MD), and the average value of the hot water shrinkage at the three points in the transverse direction (TD) corresponds to the average hot water shrinkage in the transverse direction (TD).

Here, the three regions indicated by the broken lines in FIG. 4 are all square regions of the same size in the polyamide film (substrate layer 51). In a case where the square regions satisfy the above-described distribution conditions of the hot water shrinkage, the deviation of flexibility is suppressed over the entire region of the substrate layer 51. Therefore, even if an external stress is applied, the stress is dispersed throughout the substrate layer 51, and the substrate layer 51 is less likely to be torn, which can assuredly improve the strength.

In this embodiment, the substrate layer Si is made of a polyamide film, but other layers may be laminated on the substrate layer 51 as described above.

As the substrate layer 51, a resin having a melting point higher by 10° C. or more with respect to all resins constituting the sealant layer 53 is preferably adopted, and a resin having a melting point higher by 20° C. or more is more preferably adopted. That is, in a case where this configuration is adopted, it is possible to avoid the adverse effect of heat on the substrate layer 51 when thermally bonding the sealant layer 53.

The sealant layer (heat-fusible resin layer, thermoplastic resin layer) 53 has a role of providing excellent chemical resistance against a strong corrosiveness electrolyte used in a lithium-ion secondary battery or the like, and also providing heat sealing property to the packaging material 1.

The sealant layer 53 is not particularly limited but is preferably a heat-fusible resin non-stretched film layer. The heat-fusible resin non-stretched film is preferably formed of a non-stretched film made of at least one type of heat-fusible resin selected from the group consisting of polyethylene, polypropylene, an olefin-based copolymer, and an acid-modified product and ionomers thereof, from the view point of the chemical resistance and the heat-fusible property.

The thickness of the sealant layer 53 is preferably set to 20 μm to 80 μm, more preferably set to 25 μm to 50 μm. That is, the generation of pinholes can be sufficiently prevented by setting the thickness to 20 μm or more, and it is possible to reduce the amount of the resin used and reduce the cost by setting the thickness to 80 μm or less.

Note that the sealant layer 53 may be a single layer or multiple layers. In the case of multiple layers, a three-layer film in which a random polypropylene film is laminated on both surfaces of a block polypropylene film can be exemplified.

In this embodiment, the metal foil layer 52 plays a role of a gas barrier property for preventing the invasion of oxygen and moisture.

The metal foil layer 52 is not particularly limited and may be exemplified by an aluminum foil, a copper foil, and a stainless-foil. An aluminum foil is generally used. Among them, an aluminum foil can be suitably used. In particular, in the case of using an Al—Fe-based alloy foil containing Fe of 0.7 mass % to 1.7 mass %, excellent strength and ductility can be obtained, resulting in good moldability.

The thickness of the metal foil layer 52 is preferably set to 20 μm to 100 μm, more preferably set to 25 μm to 60 μm. That is, when the thickness is set to 20 μm or more, it is possible to prevent pinhole generation during rolling in the production of a metal foil, and when the thickness is set to 100 μm or less, it is possible to reduce the stresses during stretch forming and drawing, thereby improving moldability.

Although the resin substrate layer 51 and the resin sealant layer 53 are laminated on the outer surface side and the inner surface side of the metal foil layer 52, there is a possibility that light, oxygen, and liquid may enter the resin layers 51 and 53 from the outer side (substrate layer 51 side), although there is a very small amount, and there is a possibility that the content (electrolyte of a battery, foods, pharmaceutical products, and the like) may penetrate from the inner side (sealant layer 53 side). When these intrusions reach the metal foil layer 52, they corrode the metal foil layer 52. Therefore, in the present invention, the metal foil layer 52 can be improved in the corrosion resistance by forming a chemical conversion coating film 63 having a high corrosion resistance on the surface of the metal foil layer 52.

For example, in the case of a chromate treatment, an aqueous solution of a mixture of any one of the following mixtures 1) to 3) is applied to the surface of the metal foil subjected to a degreasing treatment, and then dried.
1) a mixture of phosphoric acid, chromic acid, and at least one of metal salts of fluoride and non-metal salt of fluoride
2) a mixture of phosphoric acid, any one of an acryl-based resin, a chitosan derivative resin, and a phenol-based resin, and at least one of chromic acid and chromium (III) salt
3) a mixture of phosphoric acid, any one of an acryl-based resin, a chitosan derivative resin, and a phenol-based resin, at least one of chromic acid and chromium (III) salt, and at least one of metal salt of fluoride and non-metal salt of fluoride

The chromium adhesion amount of the chemical conversion coating film 63 may be set to 0.1 mg/m² to 50 mg/m², and more preferably set to 2 mg/m² to 20 mg/m².

It should be noted that the chemical conversion coating film 63 may be applied to both the surfaces of the metal foil layer 52 and either one of the surfaces.

In this embodiment, the first adhesive layer (colored adhesive layer) 61 is a layer that is responsible for bonding the metal foil layer 52 and the substrate layer 51 and imparts a color (including an achromatic color) to the outer surface of the packaging material 1. The first adhesive layer (colored adhesive layer) 61 is constituted by a cured film (colored adhesive cured film) of a colored adhesive composition containing a color pigment and a particular adhesive (adhesive component).

The color pigment is not particularly limited, and an azo-based pigment, a phthalocyanine-based pigment, a condensed polycyclic pigment, an inorganic-based pigment, and the like can be suitably used. Further, as the black pigment, a carbon black can be exemplified, and as the white pigment, TiO₂, SiO₂ can be exemplified.

As the color pigment, a color pigment having an average particle diameter of 0.05 μm to 5 μm is preferably used, and a particularly preferred average particle diameter is 0.1 μm to 2.5 μm.

When dispersing the pigment, it is preferable to disperse the pigment by using a pigment disperser, and when dispersing the pigment, it is also possible to use a pigment dispersant, such as, e.g., a surfactant.

However, when a pigment having a small average particle diameter is added to an adhesive, when the pigment is directly added, secondary cohesive grains of the pigment may be formed, and thus the pigment may not be uniformly dispersed in the adhesive.

For this reason, for example, a liquid coloring agent composed of an ink (also referred to as a “high-concentration ink”) in which a pigment is dissolved in a component other than a pigment such as a colorant described later is prepared, and the liquid coloring agent is added to and mixed with a main agent for adhesive. As a result, it is less likely to generate secondary cohesive particles, sediment, and the like of the pigment, and it is possible to generate a colored adhesive composition in which the pigment is uniformly dispersed in the adhesive at a predetermined content.

The ink as a liquid coloring agent is produced as follows. That is, a coloring agent, such as, e.g., a pigment, is mixed with a vehicle (a mixture of a resin and a solvent) as a color spreading agent to form an ink base. To this, an auxiliary agent (surfactant, a viscosity modifier, an antistatic agent, an antioxidant, a pigment dispersant, a leveling agent, an anti-settling agent, an antifoaming agent, and the like) is added, and a kneading and dispersing process using various mills is performed to uniformly disperse the coloring agent.

As the resin for the vehicle, it is possible to use one or two or more kinds of copolymers of vinyl chloride and vinyl acetate, chlorinated rubber, chlorinated polypropylene, acrylic resin, polyamide resin, polyurethane resin, and nitrocellulose in combination. In the present invention, it is preferable to use the same polyester resin as that of the main agent for adhesive as a vehicle, so that the compatibility (mixing) with the adhesive main agent can be improved.

As the solvent for the vehicle, one or two or more kinds of, e.g., tolylene, methyl ethyl ketone, ethyl acetate, and isopropyl alcohol can be used in combination. In the present invention, as the solvent for the vehicle, it is preferable to use ethyl acetate which is also used as a solvent for adhesive, and as an auxiliary solvent, it is also possible to use tolylene or methyl ethyl ketone as needed.

As the pigment, as described above, an azo-based pigment, a phthalocyanine-based pigment, a condensed polycyclic pigment, an inorganic-based pigment, or the like can be used, and a carbon black can be particularly recommended as a black pigment.

The compounding ratio of each component constituting the ink is preferably 15 mass % to 25 mass % for the vehicle resin, 40 mass$ to 70 mass % for the vehicle solvent, 5 mass % to 50 for the coloring agent (pigment), and 1 mass % to 5 mass % for the auxiliary agent.

In the present invention, as the coloring agent, a carbon black (CB) is used, and black ink having a pigment density of 30 mass % to 40 mass % (resin: a solvent: CB: auxiliary agent=15 mass % to 25 mass %: 40 mass % to 45 mass %: 30 mass % to 40 mass %: 3 mass % to 5 mass %) is prepared in advance as a liquid coloring agent.

In the method for producing the ink, a step (preparation step) of mixing a vehicle (polyester resin, solvent), a pigment (carbon black) and another auxiliary agent is important. In the preparation step, it is preferable to use a solvent as an ink component so that the resin component can be easily kneaded.

In particular, when an ink containing a pigment is produced, it is preferable to include a step (dispersing step) of kneading a mixture containing a resin, a solvent, a pigment, and the like in the preparation step or after the preparation step, and finely dispersing the particles of the pigment to a desired particle size.

In this dispersing step, for example, various dispersing machines, such as, e.g., a paint shaker, a ball mill, an attritor, a sand mill, a bead mill, a dyno-mill, a roll mill, an ultrasonic mill, and a high-pressure collision dispersing machine can be used, for example. In the dispersing step, one or a plurality of dispersing steps may be performed using one type of dispersing machine, or a plurality of dispersing steps may be performed using two or more types of dispersing machines in combination.

When an ink containing a pigment is produced, the dispersing step described above is important. By adding a highly concentrated and uniformly dispersed ink to a main agent for adhesive so that the pigment content becomes a predetermined amount, generation of secondary aggregated grains between the pigments is suppressed. Thus, the pigment can be uniformly dispersed in the adhesive main agent. Therefore, even if it left for several months after adding the pigment to the adhesive, precipitation of the pigment does not occur, and a main agent for adhesive having good pigment dispersibility is obtained.

By reacting the pigmented main agent (polyester resin) for adhesive with an isocyanate curing agent, it is possible to obtain a uniform-colored adhesive composition free from coating defects due to the pigment secondary aggregate particles. Further, it is possible to obtain a colored adhesive cured film having a predetermined good Young's modulus and having good shielding, bonding property, water resistant, and chemical resistance.

The adhesive components of the first adhesive layer 61 are configured by an adhesive containing a two-part curing type polyester urethane resin composed of a polyester resin as a main agent and a polyfunctional isocyanate compound as a curing agent. In the present invention, by defining the molecular weight of a polyester resin which is a main agent of the above-described two-part curing type polyester urethane resin and the type of the polyfunctional isocyanate compound which is a curing agent. The adhesive strength and moldability can be improved to suppress the delamination when deep forming is performed at the time of molding the packaging material 1.

The above-described polyester resin as a main agent is a copolymer composed of dicarboxylic acid and dialcohol as raw materials, and the preferred materials and compositions are as follows.

It is preferable to use both aliphatic dicarboxylic acid and aromatic dicarboxylic acid as the above-described dicarboxylic acid. Further, the odd and even methylene number of the methylene chain of the aliphatic dicarboxylic acid is a factor affecting the crystalline of the resin. Dicarboxylic acid having an even methylene number preferably uses aliphatic dicarboxylic acid having an even number of methylene because it produces a hard plastic having a high crystalline property. As the aliphatic dicarboxylic acid having an even methylene number, succinic acid (methylene number is 2), adipic acid (methylene number is 4), suberic acid (methylene number is 6), and sebacic acid (methylene number is 8) can be exemplified

As the aromatic dicarboxylic acid, isophthalic acid, terephthalic acid, naphthalenedicarboxylic acid, and phthalic anhydride can be exemplified.

Further, the content rate of the aromatic dicarboxylic acid to the sum of aliphatic dicarboxylic acid and aromatic dicarboxylic acid is preferably within the range of 40 moles to 80 moles. In other words, it is desirable to keep the content rate of the aliphatic dicarboxylic acid within the range of 20 mole % to 60 mole %. In this case, a resin having high adhesive strength and high moldability can be produced, and the resin can be molded into a case having a high molded article sidewall. Further, it is possible to provide a packaging material 1 capable of suppressing the delamination between the metal foil layer 52 and the substrate layer 51.

Here, when the content rate of aromatic dicarboxylic acid is less than 40 moles, the film physical property is lowered, and cohesive peeling is likely to occur, which may cause delamination.

On the other hand, when the content rate of aromatic dicarboxylic acid exceeds 80 moles, the resin becomes hard, and the adhesive performance tends to deteriorate. The particularly preferred content rate of the aromatic dicarboxylic acid is 50 moles to 70 mole %.

Examples of dialcohol in the polyester resin as a main agent of the adhesive component include ethylene glycol, propylene glycol, 1,3 butanediol, 1,4-butanediol, diethylene glycol, dipropylene glycol, neopentyl glycol, 1,5-pentanediol, 1,6-hexanediol, octanediol, 1,4-cyclohexanediol, and 2-butyl-2-ethyl-1,3-propanediol.

In the molecular weight of the polyester resin, it is preferable that the number average molecular weight (Mn) be set within a range of 8,000 to 25,000, the weight average molecular weight (Mw) be set within a range of 15,000 to 50,000, and the ratio (Mw/Mn) thereof be set to 1.3 to 2.5. When the number average molecular weight (Mn) is 8,000 or more and the weight average molecular weight (Mw) is 15,000 or more, appropriate coating film strength and heat resistance can be obtained. When the number average molecular weight (Mn) is 25,000 or less, and the weight average molecular weight (Mw) is 50,000 or less, appropriate coating film elongation can be obtained without becoming too hard.

Further, when the ratio (Mw/Mn) thereof is 1.3 to 2.5, suitable molecular weight distribution is obtained, and a balance between adhesive coating suitability (wide distribution) and performance (narrow distribution) can be maintained.

In the above-described polyester resin, the particularly preferred number average molecular weight (Mn) is 10,000 to 23,000, the particularly preferred weight average molecular weight (Mw) is 20,000 to 40,000, and the particularly preferred ratio (Mw/Mn) is 1.5 to 2.3.

Further, the molecular weight of the above-described polyester resin can be adjusted by changing the chain with isocyanate that is multifunctional. That is, when polyester components in the main agent are linked by NCO, a hydroxyl group polymer is formed at the end, and the molecular weight of the polyester resin can be adjusted by adjusting the equivalent ratio between the isocyanate group and the hydroxyl group of polyester. In the present invention, it is preferable to use a polyester resin connected such that the equivalent ratio (OH/NCO) is within the range of 1.01 to 10. Further, as other methods for adjusting the molecular weight, changing the reaction conditions (adjusting the mixing molar ratio of the dicarboxylic acid and the dialcohol) of the polycondensation reaction of the dicarboxylic acid and the dialcohol can be exemplified.

Further, in this embodiment, an epoxy-based resin or an acryl-based resin may be added as an additive to the main agent in the adhesive components.

As the polyfunctional isocyanate compound which is a curing agent of adhesive components, various isocyanate compounds of an aromatic system, an aliphatic system, and an alicyclic system can be used. Specifically, a multifunctional isocyanate product or thereof modified product composed of one or two or more types of diisocyanates, such as, e.g., hexamethylene diisocyanate (HDI), isophorone diisocyanate (IPDI) as aliphatic system, tolylene diisocyanate (TDI), and diphenylmethane diisocyanate (MDI) as aromatic system, can be exemplified.

Examples of the modified product include adduct with polyfunctional active hydrogen compounds, such as, e.g., water, glycerol, and trimethylolpropane, and isocyanurate, carbodiimide, a polyfunctional isocyanate modified product by a multimerization reaction such as polymeric reaction, and one or two or more of these may be mixed and used. However, in order to increase the adhesive strength after curing and obtain a peel-preventing effect of the substrate layer 51, it is preferable to contain an aromatic isocyanate compound in the amount of 50 moles or more. The more preferable amount of the aromatic isocyanate compound is 70 moles or more.

In the two-part curing type polyester urethane resin of the adhesive components, the main agent and the curing agent are preferably blended at a ratio of 2 moles to 25 moles of the isocyanate functional group (—NCO) to 1 mole of the polyol hydroxyl group (—OH). When the molar ratio (—NCO)/(—OH) becomes less than 2, which is low in the isocyanate functional group (—NCO), adequate coating film strength and heat resistance may not be obtained due to the insufficient curing reaction.

On the other hand, when the (—NCO)/(—OH) exceeds 25, and the isocyanate functional group (—NCO) increases, the reaction with the functional group other than a polyol may be excessively advanced, and the coating film may become too hard, resulting in an inadequate elongation. The particularly preferred molar ratio (—NCO)/(—OH) of the polyol hydroxyl group and isocyanate functional group is 5 to 20.

In the colored adhesive composition configured by an adhesive (two-part curing type polyester urethane resin) and a liquid coloring agent (resin, solvent, CB, auxiliary agent), the cured film (colored adhesive curing layer) after reaction preferably has the following physical properties.

In order to ensure good moldability of the sealing packaging material and the bonding strength between the layers, the cured film is preferably 450 MPa to 700 MPa in Young's modulus by a tensile test (JIS K7161-1), and is particularly preferably 450 MPa to 650 MPa.

Further, the breaking strength by a tensile test according to JIS K7161-1 is preferably 20 MPa to 60 MPa, and the particularly preferred breaking strength is 30 MPa to 50 MPa. Further, the breaking elongation by a tensile test according to JIS K7161-1 is preferably 208 to 100%, the particularly preferred breaking elongation is 208 to 60%, and more preferably preferred breaking elongation is 218 or more.

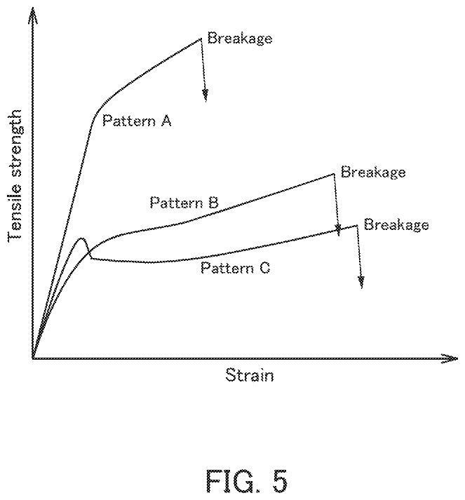

Furthermore, it is preferable that the tensile stress-strain curve (S-S curve) do not exhibit a decrease in strength before breakage. FIG. 5 shows three patterns of S-S curves. The pattern A is small in the strain amount with respect to the tensile stress, and the pattern B is large in the strain amount with respect to the tensile stress. However, in both the patterns, the strain amount increases with the increase in tensile stress, and no strength reduction prior to breaking was observed. On the other hand, in the pattern C, the tensile stress decreases in the process of increasing the strain amount, which shows a decrease in strength prior to the breaking. In the present invention, it is preferable that the cured film of the two-part curing type adhesive agent do not reduce in strength in the S-S curve. More preferably, the S-S curve has no bending point at which the strength rapidly changes.

Note that in the packaging material of the present invention, the colored adhesive cured film contains a predetermined amount of color pigment, and this color pigment acts as a reinforcing material. Thus, the Young's modulus of the colored adhesive cured film is higher as compared with the Young's modulus of an adhesive cured film not containing a color pigment. This higher Young's modulus allows the packaging material of the present invention to obtain good moldability.

The adhesive containing the above-described two-part curing type polyester urethane resin is adjusted as follows. That is, dicarboxylic acid and dialcohol, which are raw materials of a polyester resin, are condensed and polymerized. If required, it is further chain-extended with isocyanate, which is multifunctional. Various additives, such as, e.g., a solvent and an urethanization catalyst, a coupling agent for improving adhesive force, an epoxy resin, an antifoaming agent, a leveling agent, a UV absorber, and an antioxidant are mixed to obtain a fluidized polyester resin solution. Then, a polyfunctional isocyanate compound or a solvent which is a curing agent is blended therewith to obtain a low-viscosity fluid.

Preferable conditions (1) and (2) of the components in the colored adhesive composition constituting the first adhesive layer 61 are shown below. Note that the content rate described below denotes a ratio of a solid component that does not contain a solvent.

(1) a preferable content rate of the color pigment with respect to the sum of the color pigment and the polyester resin (main agent of a two-part curing type polyester urethane resin) is 2 mass % or more and less than 5% by weight. By setting the content of the color pigment to less than 5% by weight, it is possible to sufficiently suppress delamination of the substrate layer, such as, an ONY (biaxially oriented nylon) film, even in a severe environment, such as, e.g., a high-temperature and high-humidity environment or a hot water immerse environment.

(2) The application quantity of the colored adhesive composition as the first adhesive layer 61 is 5 g/m² to 10 g/m².

Based on the above-described (1) and (2), the content of the color pigment contained in the first adhesive layer 61 is within a range of 0.1 g/m² or more and less than 0.5 g/m². When the content of the color pigment is less than 0.25 g/m², the shielding effect and the visual effect are insufficient, which may be problematic in terms of design, and is not preferable. Further, when the content of the color pigment exceeds 0.45 g/m², the improvement in visual effectiveness is almost eliminated, and rather, peeling in a hot water submersion test, which will be described later, may easily occur. Thus, the effective content of the color pigment contained in the first adhesive layer 61 of the present invention is within a range of 0.25 g/m² to 0.45 g/m², and the more preferred content of the color pigment is within a range of 0.25 g/m² to 0.35 g/m².

In a case where the battery packaging material is subjected to a hot water submersion test at 45° C. as the most stringent environmental test after molding, when the content of the color pigment exceeds 0.45 g/m², the first adhesive layer 61 becomes hard and brittle, reducing the adhesive force to the metal foil layer 52, which may causes the delamination of the substrate layer (heat-resistant resin layer) 51 by a hot water submersion test.

However, in a typical environmental test (high temperature high-humidity storage test of 70° C.×90% RH) after molding the battery packaging material, when the content of the color pigment is less than 0.5 g/m², the substrate layer (heat-resistant resin layer) 51 does not delaminate during the storage test and therefore can be used.

Note that in a case where the content of the color pigment is 0.5 g/m² or more, the substrate layer 51 is more likely to delaminate during a high-temperature and high-humidity storage test.

When the application quantity of the first adhesive layer (colored adhesive composition) 61 is less than 5 g/m², the content of the color pigment is reduced, the effectiveness of concealing the metal foil layer is reduced as described above, and metallic luster is visually recognized, which may impair the profound feeling.

Further, when the application amount of the first adhesive layer 61 exceeds 10 g/m², formability significantly deteriorates, leading to an increase in cost. The preferred application amount of the colored adhesive composition is 6 g/m² to 10 g/m².

Further, the method of bonding the metal foil layer 52 and the substrate layer 51 is not limited, but a method called “dry lamination” can be recommended. Specifically, the above-described colored adhesive composition is applied to the upper surface (outer surface) of the metal foil layer 52, or the lower surface (inner surface) of the substrate layer 51, or both of these surfaces, the solvent is caused to be evaporated to form a dry film, and then the metal foil layer 52 and the substrate layer 51 are bonded to each other. Thereafter, the two-part curing type polyester urethane resin is further cured according to the curing conditions thereof. With this, the metal foil layer 52 and the substrate layer 51 are bonded to each other via the first adhesive layer 61. Note that the coating method of the colored adhesive composition can be exemplified by a gravure coating method, a reverse roll coating method, a ripple role coating method, and the like.

Examples of the second adhesive layer (non-colored adhesive layer) 62 include, but are not limited to, an adhesive layer formed of a polyurethane-based adhesive, an acrylic-based adhesive, an epoxy-based adhesive, a polyolefin based adhesive, an elastomer-based adhesive, a fluorine-based adhesive, an acid-modified polypropylene adhesive, and the like.

Among them, an acrylic-based adhesive and a polyolefin-based adhesive are preferably used, and in this case, it is possible to improve the electrolyte resistance and water vapor barrier property of the packaging material 1.

The method of bonding the metal foil layer 62 and the sealant layer 53 is not limited, but as in the method of bonding the metal foil layer 52 and the substrate layer 51, a dry lamination method in which an adhesive constituting the second adhesive layer 62 is applied and dried and then bonding is performed can be exemplified.

The matte coat layer 50 is laminated on the outer surface of the substrate layer 51 and is a layer for improving moldability by imparting good slipperiness to the surface of the packaging material 1.

The matte coat layer 50 is made of a resin composition in which inorganic fine particles are dispersed in the heat-resistant resin components. In particular, it is preferable that the matte coat layer 50 be made of a resin composition containing 0.1 mass % to 1 mass % of inorganic fine particles having an average particle diameter of 1 μm to 10 μm in the two-part curing type heat-resistant resin.

As the heat-resistant resin, an acryl-based resin, an epoxy-based resins, a polyester-based resin, a urethane-based resin, a polyolefin-based resin, and a fluorine-based resin are exemplified, but in particular, from the viewpoint of excellent heat resistance and chemical resistance, it is preferable to use a fluorine-based resin based on tetrafluoroethylene or fluoroethylene vinyl ether.

As the inorganic fine particles, it is not particularly limited, but silica, alumina, calcium oxide, calcium carbonate, calcium sulfate, and calcium silicate are exemplified, and among them, silica is preferably used.

The matte coat layer 50 is formed by applying a matte coat composition containing the above-described inorganic fine particles and heat-resistant resin to the surface of the substrate layer 51 and curing.

The thickness of the matte coat layer 50 after curing is preferably 0.5 μm to 5 μm. When it is thinner than this lower limit, slipperiness improvement cannot be expected. When it is thicker than the upper limit, there is a risk of cost increase, which is not preferable. The particularly preferred thickness is 1 μm to 3 μm.

The gloss value of the surface of the matte coat layer 50 is preferably set to 18 to 158 at a 60° reflection angle measurement value according to JIS 28741. The gross value is obtained, for example, by measuring at a 60° angle of reflectance using a gloss measuring instrument “micro-TRI-gloss-s” manufactured by BYK Corporation.

The timing of the step of forming the matte coat layer 50 is not limited, but the step is preferably performed following the step of bonding the substrate layer 51 to the metal foil layer 52 via the first adhesive layer 61. Currently, the step is performed after bonding a non-stretched polypropylene (CPP) film to the substrate layer 51.

Note that in the above-described embodiment, the description was made by exemplifying the case in which the sealing packaging material of the present invention is used as a packaging material for a power storage device, such as, e.g., a battery, but the present invention is not limited thereto. The packaging material of the present invention can also be used as a packaging material for sealing or encapsulating contents, such as, e.g., foods and pharmaceuticals.

In the above-described embodiment, an example is shown in which a sheet-like exterior material (packaging material) 1 is used as the cover member 3, but the present invention is not limited thereto. In the present invention, the cover member 3 may be subjected to molding processing. For example, the cover member may be configured by a molded article having a bat-Shaped cross-section in which the central portion is formed to be recessed (formed to bulge) upward, and the outer peripheral edge portion of the hat-shaped cover member is integrally joined to the tray member described above to cover the tray member from above. Further, in the present invention, a casing may be formed by stacking two unmolded sheets-like exterior materials (packaging materials) 1 to sandwich a power storage device main body therebetween, and heat-sealing the outer peripheral edge portions thereof.

Further, in the above-described embodiment, an example is shown in which a casing is formed using two packaging materials (outer packaging laminate materials), but the present invention is not limited thereto. In the present invention, the number of packaging materials forming the casing is not limited and may be one or three or more.

Needless to say, in the packaging material of the present invention, it is not always necessary to provide the matte coat layer 50, the chemical conversion coating film layers 63, and the like which are preferably required.

### EXAMPLES

Next, Examples including the gist of the present invention and Comparative Examples for deriving the effects will be described. Needless to say, the present invention is not limited to the following examples.

In the following Examples 1 to 8 and Comparative Examples 1 to 5, packaging materials having the laminated structure shown in FIG. 3 were prepared. As shown in Table 1, in Examples and Comparative Examples, the configuration of the first adhesive layer (coloring adhesive layer) differs from each other, and the remaining configurations are the same.

TABLE 1

| | | | Examples | | | | | |
|---|---|---|---|---|---|---|---|---|
| | | | 1 | 2 | 3 | 4 | 5 | 6 |
| Colored | Main agent | Number average molecular | 12,000 | — | — | — | — | — |
| adhesive | | weight Mn | | | | | | |
| layer | | Weight average molecular | 20,500 | — | — | — | — | — |
| composition | | weight MW | | | | | | |
| | | Mn/Mw | 1.7 | — | — | — | — | — |
| | Curing agent | Content of aromatic | 100 | — | — | — | — | — |
| | | isocyanate compound (molar %) | | | | | | |
| | Molar ratio (NCO/OH) | | 10 | — | — | — | — | — |
| | Carbon black content (mass %) | | 2.5 | 3.5 | 4.2 | 4.6 | 4.8 | 4.0 |
| | Colored adhesive agent application amount (g/m²) | | 10 | 7.5 | 6.5 | 6.0 | 5.5 | 8.0 |
| | Carbon black content (g/m²) | | 0.25 | 0.26 | 0.27 | 0.28 | 0.26 | 0.32 |
| Cured film | Young's modulus (MPa) | | 460 | 510 | 570 | 590 | 620 | 550 |
| | Breaking strength (MPa) | | 32 | 33 | 34 | 35 | 35 | 34 |
| | Breaking elongation (%) | | 23 | 35 | 45 | 50 | 52 | 43 |
| | S—S curb pattern | | A | A | A | A | A | A |
| Evaluation | Appearance of the molded article (shielding) | | ◯ | ◯ | ◯ | ◯ | ◯ | ◯ |
| | Peeling | After high-temperature | ⊚ | ⊚ | ⊚ | ⊚ | ⊚ | ⊚ |
| | | and high-humidity test | | | | | | |
| | | After warm water | ⊚ | ⊚ | ⊚ | ⊚ | ⊚ | ⊚ |
| | | immersion test | | | | | | |

| | | | | | | |
|---|---|---|---|---|---|---|
| Mouldability | ◯ | ⊚ | ⊚ | ⊚ | ⊚ | ⊚ |

| | | | Examples | Comparative examples | | | |
|---|---|---|---|---|---|---|---|
| | | | 7 | 1 | 2 | 3 | 4 |
| Colored | Main agent | Number average molecular | — | — | — | — | — |
| adhesive | | weight Mn | | | | | |
| layer | | Weight average molecular | — | — | — | — | — |
| composition | | weight MW | | | | | |
| | | Mn/Mw | — | — | — | — | — |
| | Curing agent | Content of aromatic | — | — | — | — | — |
| | | isocyanate compound (molar %) | | | | | |

| | | | | | | |
|---|---|---|---|---|---|---|
| | Molar ratio (NCO/OH) | — | — | — | — | — |
| | Carbon black content (mass %) | 4.9 | 0 | 1.5 | 8.0 | 15.0 |
| | Colored adhesive agent application amount (g/m²) | 9.0 | 6.0 | 8.0 | 7.0 | 5.0 |
| | Carbon black content (g/m²) | 0.44 | 0 | 0.12 | 0.56 | 0.75 |
| Cured film | Young's modulus (MPa) | 630 | 400 | 420 | 740 | 850 |
| | Breaking strength (MPa) | 35 | 30 | 31 | 37 | 40 |
| | Breaking elongation (%) | 54 | 18 | 20 | 15 | 11 |
| | S—S curb pattern | A | A | A | A | A |
| Evaluation | Appearance of the molded article (shielding) | ◯ | X | X | ◯ | ◯ |

| | | | | | | |
|---|---|---|---|---|---|---|
| Peeling | After high-temperature | ⊚ | ⊚ | ⊚ | Δ | X |
| | and high-humidity test | | | | | |
| | After warm water | ◯ | ⊚ | ⊚ | X | X |
| | immersion test | | | | | |

| | | | | | |
|---|---|---|---|---|---|
| Mouldability | ⊚ | ◯ | ◯ | X | X |

### Example 1

As a metal foil layer, an aluminum foil made of JIS H4160 A8079 having a thickness of 35 μm was prepared. Further, on both surfaces of the aluminum foil, a chemical conversion treatment solution composed of polyacrylic acid, trivalent chromic compound, water, and alcohol was applied and then dried at 150° C. to form a chemical conversion coating film. The chromium adhesion amount by this chemical conversion coating film was 10 mg/m².

As a substrate layer, a 15 μm-thick biaxially stretched nylon film was prepared. The bonding surface (lower surface) of this film to be bonded to the first adhesive layer was subjected to a corona treatment.

The biaxially stretched nylon film as a substrate layer has the following property. The hot water shrinkage in the TD was 3.88. The hot water shrinkage in the MD was 2.38. The difference (TD-MD) between the hot water shrinkage in the TD and the hot water shrinkage in the MD was 1.58. The elastic modulus in the TD was 1.5 GPa. The elastic modulus in the MD was 2.0 GPa. The breaking strength in the TD was 322 MPa. The breaking strength in the MD was 281 MPa. The number average molecular weight of the polyamide was 18,000.

The colored adhesive composition constituting the first adhesive layer was prepared by the following method using a two-part curing type polyester urethane resin as an adhesive component and a carbon black as a color pigment.

First, a polyester resin (polyester polyol), which is a main agent of a two-part curing type polyester urethane resin, was prepared as follows. That is, 30 part by mole of neopentyl glycol, 30 part by mole of ethylene glycol, and 40 part by mole of 1,6-hexanediol were melted at 80° C., and 30 part by mole of adipic acid (methylene number 4), which is aliphatic dicarboxylic acid, and 70 part by mole of isophthalic acid, which is aromatic dicarboxylic acid, were subjected to a condensation polymerization reaction at 210° C. for 20 hours while stirring to obtain a polyester polyol. In this polyester polyol, the number average molecular weight (Mn) was 12,000, the weight average molecular weight (Mw) was 20, 500, the ratio (Mw/Mn) thereof was 1.7. Further, 60 parts by mass of ethylacetate was added to 40 parts by mass of a polyester polyol to prepare a fluid polyester polyol resinous solution. Further, the hydroxyl value was 2.2 mgKOH/g (solution value).

On the other hand, 20 parts by mass of the same polyester polyol as described above as a resin for vehicle, 40 parts by mass of ethyl acetate as a solvent for vehicle, 35 parts by mass of a carbon black having an average particle diameter of 1.0 μm as a coloring agent, and 5 parts of a combination of a pigmented dispersant and an anti-settling agent as other auxiliary agents were mixed, and this mixture was kneaded in a disperser to prepare a high-concentration carbon black contained ink (a black ink with a carbon black content of 35% by weight).

Next, 100 parts by mass of the above-mentioned polyester polyol resin solution, 64.4 parts by mass of ethyl acetate, and the above-mentioned high-concentration ink carbon black contained ink were blended by a required amount, and the carbon black contained ink was dispersed using a pigment disperser to obtain a main agent for adhesive containing a color pigment (carbon black). Then, 7.1 parts by mass of an adduct (13.0% of NCO, 75% of a solid content) of tolylene diisocyanate (TDI) (aromatic) and trimethylolpropane which are aromatic isocyanate compounds as a curing agent was blended to 100 parts by mass of a main agent containing the color pigment, and 34.1 parts by mass of ethyl acetate was further blended and stirred thoroughly to thereby a colored adhesive composition. In this colored adhesive composition, the molar ratio (—NCO)/(—OH) of the isocyanate functional group (—NCO) and the polyester polyol hydroxyl group (—OH) was 10. As shown in Table 1, the content of the pigment in this colored adhesive composition was 2.5 mass %.

The cured film (colored adhesive cured film) was prepared by the above-described colored adhesive composition to evaluate the physical properties. Specifically, the colored adhesive composition was applied to the non-adhesive untreated PP film so that the thickness after drying becomes 10 μm, and dried. Thereafter, curing was performed by aging at 60° C. until the residual isocyanate became 5% or less. The cured film was peeled from the untreated PP film and cut into 15 mm width to obtain test pieces.

The prepared test piece was subjected to a tensile test under the conditions of a gauge length of 50 mm and a tensile speed of 100 mm/min to measure the Young's modulus, the breaking strength, and the breaking elongation. As a result, the Young's modulus was 460 MPa, the breaking strength was 32 MPa, and the breaking elongation was 238. Further, the S-S curve in the tensile test was obtained, and the pattern was the pattern A shown in FIG. 5.

On the other hand, a polyacrylic adhesive was prepared as a second adhesive layer, and an unstretched polypropylene film having a thickness of 30 μm was prepared as a sealant layer. Further, a composition for a matte coat layer was prepared as follows. 70 parts by mass of fluoroethylene vinyl ester as a heat-resistant resin, 10 parts by mass of barium sulfate as fine particles, 10 parts by mass of pulverulent silica, 5 parts by mass of polytetrafluoroethylene wax as wax, and 5 parts by weight of polyethylene resin beads as resin beads were mixed.

A first adhesive layer (colored adhesive cured film) was formed by applying a predetermined amount of a colored adhesive composition to one surface (outer surface) of an aluminum foil for the metal foil layer in which a chemical conversion coating film was formed on both surfaces and drying. The coating amount of the colored adhesive composition, the number average molecular weight Mn, the weight average molecular weight Mw, the ratio Mw/Mn, and the content (coating amount) of the carbon black were as shown in Table 1. The above-described substrate layer film was laminated on the first adhesive layer to laminate a substrate layer and aged at 60° C. for 5 days.

Then, the above-described polyacrylic adhesive as a second adhesive layer was applied to the other surface (lower surface) of the metal foil layer, and the above-described polypropylene film as a sealant layer was bonded to the lower surface (inner surface).

Further, the above-described matte coat layer composition was applied to the outer surface of the substrate layer such that the thickness after drying became 2 μm.

The laminate bonded as described above was allowed to be aged at 40° C. for 5 days to obtain an exterior material (a power storage device packaging material) of Example 1.

### Example 2 to 7 and Comparative Examples 1 to 4

As shown in Table 1, in the first adhesive layer, the pigment density (carbon black density), the colored adhesive composition application quantity, the pigment application quantity (content), the number average molecular weight Mn, and the weight average molecular weight Mw, the ratio Mw/Mn were adjusted, and packaging materials of Example 2 to 7 and Comparative Example 1 to 5 were obtained in the same manner as in the above-described Example 1.

### <Evaluation Test>

### (1) Evaluation of Concealability (Shielding Property)

The packaging materials of Examples and Comparative Examples were each visually observed from the substrate layer side (outer surface side) to confirm the concealability of the metal foil layer. Then, those having a shielding property was evaluated as “◯, and those having no shielding property was evaluated ac “×.” Evaluation results thus obtained are shown in Table 1.

### (2) Evaluation of Moldability

A press machine manufactured by Amada Co., Ltd. was prepared in which a mold having a punch shape of 33 mm×54 mm, a punch corner R of 2 mm, a punch shoulder R of 1. 3 mm, and a die shoulder R of 1 mm of a die shape was prepared. Then, each packaging material of Examples and Comparative Examples was sampled into a 100 mm×125 mm blank, and each sample was subjected to deep drawing using a press machine described above to prepare a molded article sample.

The presence or absence of pinholes and cracks in the corner portion of each molded article obtained by this deep drawing was confirmed, and the “maximum molding depth (mm)” at which pinholes and cracks did not occur was investigated and evaluated based on the following criteria. The presence or absence of cracks or pinholes in the evaluation was examined by a light transmittance method in a dark room. Among “⊚,” “◯,” and “×” of the evaluation criteria described below, “⊚” and “◯” denote acceptable (Passed),” and “×” denotes unacceptable (Failed).” The results are shown in Table 1.
⊚: There was no cracks or pin holes at the forming depth of 6 mm or more
◯: The forming depth was 5 mm or more and less than 6 mm, and there were no crack or pinhole
×: The forming depth was less than 5 mm, and there were cracks or pinholes

### (3) Evaluation on Peeling

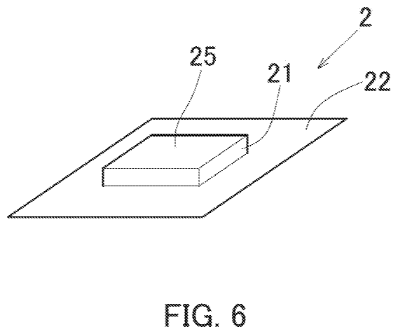

The packaging materials of Examples and Comparative Examples were each sampled to a predetermined size and subjected to deep drawing in the same manner as described above to prepare a molded article of a molded case (upside-down tray-shaped member) 2 as a molded article having a recessed portion (protrusion) 21 of 33 mm×54 mm×4.5 mm as shown in FIG. 6 and a flat flange portion 22 on the outer periphery of the protrusion. Further, the top wall (top surface) 25 of the protrusion of the molded article 2 was concavely deformed to be crushed, and then subjected to the following high-temperature high-humidity test and hot water submersion test, and the presence or absence of peeling of the substrate layer after the test was visually observed.

In the high-temperature and high-humidity test, the molded article 2 having the crushed top surface 25 was stored in an atmosphere of 70° C. and 90% moisture for two weeks, and the presence or absence of peeling of the substrate layer was confirmed. Further, in the hot water submersion test, the crushed molded article 2 was submerged in hot water at 45° C. and stored for two weeks.

For both the tests, 30 pieces of the molded articles 2 were visually observed for each Example and each Comparative Example, and evaluated based on the numbers of the molded articles 2 in which the substrate layer was peeled from the metal foil layer by the following criteria. Among “⊚”, “◯,” “Δ,” and “×” in the following evaluation criteria, “⊚,” “◯,” and “Δ” denote “Passed,” and “×” denotes “Failed.” The results are shown in Table 1.
⊚: Those peeled off was 0 piece out of 30 pieces
◯: Those peeled off was 1 or 2 pieces out of 30 pieces
Δ: Those peeled off was 3 pieces to 5 pieces out of 30 pieces,
×: Those peeled off was 6 to 30 pieces out of 30 pieces

### <Overall Evaluation>

As can be seen from the above evaluations, the packaging materials of Examples related to the present invention were excellent in shielding, moldability and peel resistance. In contrast, the packaging materials of Comparative Examples, which deviated from the gist of the present invention, were inferior to either one of evaluations as compared with the packaging materials of Examples.

### INDUSTRIAL APPLICABILITY

The packaging material of the present invention can be suitably used as a packaging material for a battery (power storage device), such as, e.g., a secondary battery (a lithium-ion secondary battery), for a notebook computer, a mobile telephone, a vehicle-mounted (mobile) or a stationary secondary battery.

This application claims priority to Japanese Patent Application No. 2022-71704, filed on Apr. 25, 2022, and Japanese Patent Application No. 2023-40851, filed on Mar. 15, 2023, the disclosure of which is incorporated herein by reference in its entirety.

The terms and expressions used herein are for illustration purposes only and are not used for limited interpretation, do not exclude any equivalents of the features shown and stated herein, and it should be recognized that the present invention allows various modifications within the scope of the present invention as claimed.

### DESCRIPTION OF SYMBOLS

1: External material (packaging material)
10: Power storage device main body
2: Tray member (packaging material, external material, packaging container)
21: Recessed portion (molded portion)
3: Cover member (packaging material, external material)
51: Substrate layer
52: Metal foil layer
53: Sealant layer
61: First adhesive layer (colored adhesive layer, colored adhesive composition, colored adhesive cored film)
63: Chemical conversion coating film

1. A packaging material comprising:
a substrate layer made of a heat-resistant resin;
a metal foil layer laminated on an inner side of the substrate layer;
a sealant layer made of a thermoplastic resin, the sealant layer being laminated on an inner side of the metal foil layer; and
a colored adhesive layer provided between the metal foil layer and the substrate layer,
wherein the colored adhesive layer is formed of a colored adhesive cured film containing a color pigment and an adhesive, and
wherein the colored adhesive cured film has a Young's modulus of 450 MPa to 700 MPa by a tensile test according to JIS K7161-1: 2014.

2. The packaging material as recited in claim 1,
wherein the colored adhesive cured film has breaking elongation of 21% to 60% by a tensile test according to JIS K7161-1:2014.

3. The packaging material as recited in claim 1,
wherein the colored adhesive layer contains the color pigment of 2 mass % or more and less than 5 mass %, and
wherein the colored adhesive layer is a colored adhesive cured film of 5 g/m² to 10 g/m².

4. The packaging material as recited in claim 1,
wherein the adhesive of the colored adhesive layer contains a two-part curing type polyester urethane resin derived from a polyester resin as a main agent and a polyfunctional isocyanate compound as a curing agent,
wherein the polyester resin as the main agent has a number average molecular weight (Mn) of 8,000 to 25,000 and a weight average molecular weight (Mw) of 15,000 to 50,000, and a ratio thereof (Mw/Mn) is 1.3 to 2.5, and
wherein the polyfunctional isocyanate compound as the curing agent contains 50 mole % or more of aromatic isocyanate.

5. The packaging material as recited in claim 4,
wherein in the two-part curing type polyester urethane resin, the polyester resin as the main agent is made from dicarboxylic acid and dialcohol, and
wherein the dicarboxylic acid contains aliphatic dicarboxylic acid and aromatic dicarboxylic acid in which a methylene number of a methylene chain is an even number, and a content rate of the aromatic dicarboxylic acid with respect to a total amount of the aliphatic dicarboxylic acid and the aromatic dicarboxylic acid is 40 mol % to 80 mol %.

6. The packaging material as recited in claim 1,
wherein the metal foil layer has a chemical conversion coating film on at least one surface of the metal foil layer.

7. The packaging material as recited in claim 1, further comprising:
a matte coat layer provided on an outer surface of the substrate layer.

8. A packaging container made of the packaging material as recited in claim 1,
wherein the packaging material is provided with a molded portion formed by subjecting the packaging material to deep drawing or stretch forming.

9. A packaging material for a power storage device, the packaging material being the packaging material as recited in claim 1.

10. A power storage device comprising:
a power storage device main body; and
the packaging material as recited in claim 9,
wherein the power storage device main body is covered with the packaging material.

11. A method of producing a colored adhesive composition constituting the colored adhesive cured film in the packaging material as recited in claim 1, the method comprising:
mixing a color pigment with a vehicle to prepare a liquid coloring agent;
mixing the liquid coloring agent with a main agent among the main agent and a curing agent constituting the adhesive to prepare a pigment contained adhesive main agent; and then
mixing the pigment contained adhesive main agent and the curing agent to produce the colored adhesive composition.
